(19) United States
(12) Patent Application Publication
(10) Pub. No.: US 2009/0196160 A1
(43) Pub. Date: Aug. 6, 2009

(54) Coating for Optical Discs

(76) Inventor: Berend Crombach, Oss (NL)

Correspondence Address: ZUBER & TAILLIEU LLP, 10866 WILSHIRE BLVD., SUITE 300, LOS ANGELES, CA, 90024, US

(21) Appl. No.: 12/083,741

(22) PCT Filed: Oct. 17, 2006
(86) PCT No.: PCT/EP2006/010616

§ 371 Date: Mar. 23, 2009

(30) Foreign Application Priority Data
Oct. 17, 2005 (GB) 0521094.3

(51) Int. Cl. G11B 3/70; C08F 2/46

(52) U.S. Cl. 369/283; 522/68; G9B/3.103

(57) ABSTRACT

An energy-curable flowable coating composition comprising a surface treated inorganic nanoparticle, a photoinitiator, and at least one energy-curable monomer, oligomer or resin. The energy-curable flowable coating can be used as a covering layer of optical discs, and is especially suited for use as a 100 micron cover layer of a Blu-Ray disc, having enhanced scratch resistance and reduced shrinkage.

### FIELD OF THE INVENTION

The present invention relates to an energy-curable, preferably UV-curable, lacquer for use on optical discs. In particular, the present invention provides an organic lacquer for optical discs, which lacquer has a high-strength, is durable when used only as a single layer, and which, moreover, has very high scratch resistance, fast curing with low shrinkage, excellent transparency and is capable of preventing the corrosion and deterioration of the thin metallic films which are an essential component of optical discs.

### BACKGROUND OF THE INVENTION

Compact Discs (CDs) represent the first generation of optical discs in which a laser beam is used to read out data stored on a plastic disc with a metallic reflective layer on top. The metallic layer is corrosion-sensitive and is protected by an organic coating. The light from the laser does not travel through the organic cover layer.

Digital Versatile Discs (DVDs) represent the second generation of optical discs in which a laser beam is used to read out data stored in a plastic disc which has one or two reflective layers. An organic layer is used as an adhesive to bond the two layers. In the case of a single sided dual layered DVD (DVD-9) the adhesives used need to be transparent to the laser beam wavelength (650 nm).

For the third generation of optical discs there are currently two options. The first is High-Definition DVD (HD-DVD), which is very similar to a DVD. The second is BluRay Discs (BD), which has more in common with a CD. HD-DVD uses an adhesive organic layer to bond two substrates, while BD uses a cover lacquer for protection. Organic layers in dual layered HD-DVD and BD need to be transparent to a laser beam with a wavelength of 405 nm. From the first to the third generations of optical discs, the organic layer has increased in importance. especially for BD, where the 100 micron thickness organic cover layer is an essential and critical part of the disc. It has multiple functions. It is part of the optical path, it protects the sensitive reflective layer and it stabilises the BD, resulting in a specification of the transparency at 405 nm (the wavelength of the blue laser).

In addition to transparency and geometric tolerances, there are additional requirements for organic cover layers for BD, such as scratch resistance and low shrinkage, and reliable processing (usually spin coating, but also other processes are possible).

It is complicated to achieve all these requirements within one single layer and therefore alternative methods were developed, such as laminatable films, multi-layer systems and/or the placing of the optical disk in a cartridge. One common way of meeting all of these requirements is to provide a multi layer system composed of one or two low shrinkage flexible layers and one or two hard high shrinkage layers. However, the provision of several layers is more expensive than the provision of a single layer, and the industry prefers a single curable layer that can be applied in the liquid state.

### SUMMARY OF THE INVENTION

In its broadest aspect, the present invention thus consists in an energy-curable flowable coating composition comprising a surface treated inorganic nanoparticle, a photoinitiator, and at least one energy-curable monomer, oligomer or resin. In addition to the energy-curable monomers and/or oligomers and/or resins, of which at least one is filled with inorganic nanoparticles, and one or more photoinitiators, additives, such as flow-additives, can also be included.

The present invention, therefore, is designed to provide an optical disc lacquer which comprises all the required properties, including scratch resistance, transparency, fast curing with low shrinkage, and which can be processed by application in a single layer in such way that a dry film with a layer thickness between 75 and 100 microns, depending on the type of BD disc, is obtained with a layer thickness tolerance of 2-3 microns over the full surface of the optical disc as is required for the BD application. Additional coating layers, cartridges or the use of laminated films can thus be avoided. This results in an increase of yield at production stage manufacturing of BD and, therefore, saves production costs. Furthermore production equipment can be simplified because the hard coat module can be eliminated which reduces investment costs.

### DESCRIPTION OF THE FIGURES

FIG. 1 shows a schematic sectional view of a BluRay Optical Disc according to a preferred embodiment of the present invention.

### DETAILED DESCRIPTION OF PREFERRED EMBODIMENTS

The present invention consists of an energy-curable flowable coating composition comprising a surface treated inorganic nanoparticle, a photoinitiator, and at least one energy-curable monomer, oligomer or resin.

The term “nanoparticles” means particles having an average particle size of the order of nanometres. The mean particle size of the nanoparticles used in the present invention is preferably from 5 to 80 nm, more preferably from 9 to 50 nm, still more preferably from 15 to 30 nm. Preferred examples of materials which may be used as the nanoparticles include silica, alumina, zirconia, noble and other metals and compounds, such as the oxides, of such metals, and ceramics. Of these, silica, alumina and zirconia are preferred, silica being most preferred. Colloidal silica, preferably having a particle size from 9 to 60 nm, is most preferred.

Preferably, the surface of the inorganic nanoparticles used contains a reactive functional group to enhance the stability of the final formulation in comparison with non surface modified nanoparticles. The reactive functional group can be an epoxy-, a (meth)acrylate- and/or an isocyanate group. The modification of the inorganic nanoparticle is essential for the stability of the final product and to build the nanoparticle into the final network of the coating. These surface-modified nanoparticles are commercially available.

The amount of nanoparticles may vary over a wide range, and the amount used should be chosen so as, on the one hand, to enhance the scratch resistance and low shrinkage of the composition on curing, whilst, on the other hand, not adversely affecting other desirable properties of the cured composition. In general, an amount of 15 to 50% by weight of the entire composition is preferred, 20 to 40% by weight of the entire composition being more preferred.

There is no particular restriction on the nature of the photoinitiator used, except as noted below, and any photoinitiator known in the art may be employed. Examples of such photoinitiators include hydroxycyclohexyl phenyl ketones; benzophenone and its derivatives; acyl phosphine based materials; sulphonium salts (such as the mixture of compounds available under the trade name UVI6992 from Dow Chemical) thianthrenium salts (such as Esacure 1187 available from Lamberti); iodonium salts (such as IGM 440 from IGM); phenacyl sulphonium salts; and thioxanthonium salts, such as those described in WO 03/072567 A1, WO 03/072568 A1, and WO 2004/055000 A1, the disclosures of which are incorporated herein by reference.

In a preferred embodiment, a single photoinitiator or a combination of any two or more thereof may be used. Certain photoinitiators may absorb light in the wavelength used by the laser to read the optical disc, and, in such as case, that photoinitiator should be avoided. For example, certain photoinitiators absorb light of wavelength around 405 nm, the wavelength of the blue laser, and so, if the composition of the present invention is to be used for the preparation of a BD, such photoinitiators should not be used. However, those same photoinitiators may be used if the optical disc is for one of the other systems. Flow additives that are silicon-based, fluorine-based or other types might also be included, if desired.

The composition of the present invention is preferably a solventless formulation, the composition being rendered flowable by appropriate choices of monomers, oligomers and/or resins. In order to ensure a smooth and even coating, it is necessary to eliminate, as far as possible, all volatile organic solvents. In some cases, minor amounts of such solvents may be present (sometimes entrained with commercially sourced components of the resin etc.), but their amounts should be minimised. For the purposes of the present invention, a solvent content lower than 3% by weight of the entire composition may be regarded as “solventless”. However, lower solvent contents, e.g. less than 2 or 1% by weight are desirable, and complete freedom from volatile organic solvents is preferred.

The composition is energy-curable, and so may be cured by various known means such as electron beam or UV, preferably UV. Accordingly, the preferred composition of the present invention is thus a UV-curable material without solvents that can be handled by standard application methods, such as spin coating, and other application methods to form a coating for use on an optical disc.

For most optical discs, such a coating preferably has a thickness of about 100 microns with a tolerance of 2-3 microns over the full surface of an optical disc. However, for a dual layer BluRay disc, the coating is preferably about 75 microns thick, with a similar tolerance, and, in fact, the coating may be whatever thickness is required for the particular purpose envisaged. The coating preferably also has a transparency greater than 85%, preferably 90%, in the wavelength of the read-out laser. The shrinkage measured after curing is preferably below 7%, more preferably below 6%. Pencil hardness is preferably at least 4H, more preferably at least 6H. Gloss loss after the Taber abrasion test is preferably 2-10%. Examples of UV-curable resins and oligomers which may be used in the present invention include polyester acrylates, polyether acrylates, urethane acrylates, epoxy acrylates or any other type of oligomeric acrylates that exhibit low shrinkage upon curing.

In addition to, or in place of the resin or oligomer, the composition may contain an energy-curable monomer. In particular, where the composition contains a resin or oligomer, the monomer may also serve as a reactive diluent. UV-curable diluting monomers can include low viscosity monofunctional, difunctional or higher functional acrylates that exhibit low shrinkage upon curing, e.g. hexanediol diacrylate, trimethylolpropane triacrylate, di-trimethylolpropane tetraacrylate, di-pentaerythritol pentaacrylate, polyether acrylates, such as ethoxylated trimethylol propane triacrylate, glycerol propoxylate triacrylate, ethoxylated pentaerythritol tetraacrylate, epoxy acrylates such as dianol diacrylate (=the diacrylate of 2,2-bis[4-(2-hydroxyethoxy)phenyl]propane, Ebecryl 150 from UCB), glycol diacrylates such as tripropylene glycol diacrylate and alkyl acrylates and methacrylates (such as hexanediol diacrylate, isobornyl acrylate, octadecyl acrylate, lauryl acrylate, stearyl acrylate and isodecyl acrylate, and the corresponding methacrylates).

In addition to the energy-curable monomers and/or oligomers and/or resins, of which at least one is filled with inorganic nanoparticles, and one or more photoinitiators, additives, such as flow-additives, can also be included.

The viscosity of the single-layer optical disc lacquer has to be at a sufficiently high level to be able to manufacture the single-layer cover layer of the BD in a single step. Typically a viscosity of approximately 1500 to 2500 mPa·s is needed. However, the viscosity of the composition of the present invention depends on the specific requirements of the application process. The viscosity can be set between 100 and 10000 mPas without compromising the above mentioned properties. The viscosity of the final formulation is preferably higher than 100 mPa·s but lower than 10,000 mPa·s, more preferably higher than 500 mPa·s but lower than 5,000 mPa·s, and most preferably higher than 700 mPa·s but lower than 3,000 mPa·s.

The composition of the present invention is applied to an optical disc and cured by exposure to energy, e.g. UV, as is well known in the art, using conventional equipment and techniques. The result is an optical disc having a coating of the composition of the present invention, which has been cured. Accordingly, such a disc also forms part of the present invention and the present invention further consists of an optical disc comprising a substrate bearing a reflective layer, the reflective layer being covered with a layer comprising the cured composition of the present invention. The reflective layer may be any suitable material commonly used in this field, for example a metal such as gold, silver, a silver alloy or aluminium. The substrate will commonly be a plastics material, such as is conventionally used.

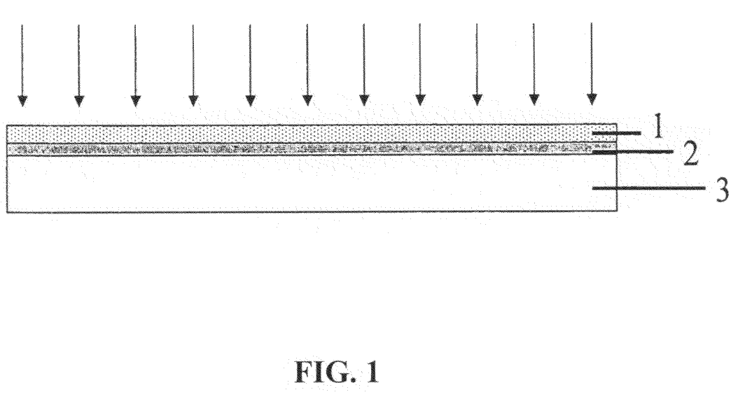

FIG. 1 shows a schematic sectional view of a BluRay Optical Disc according to a preferred embodiment of the present invention. As shown in FIG. 1, layer 1 is the organic cover layer, which has a thickness of 100 μm with a tolerance of ±3 μm. Layer 2 is the metallic layer, which is usually made from silver or silver-alloy, but can also be of any other reflective material. Layer 3 is the plastic substrate, usually polycarbonate, with a pit structure on top that contains the stored data directly under the metallic layer. The information is read by a laser beam through the organic cover layer 1.

Preferably, the organic cover layer or coating has a pencil hardness in accordance with ISO015184 of over 4H, more preferably at least 6H. By setting the pencil hardness value over this value, high strength for the single layer coating can be ensured, which is needed to prevent data loss by mechanical deformation of the single layer coating.

Preferably, the indentation hardness of the single layer coating obtained from the indentation hardness test in accordance with U; PHV 623-93/487 (Philips Electronics test standard) is under 5 μm, more preferably under 2.5 μm, indentation depth. By setting the indentation depth under this value, the stability and hardness for the single layer coating 1 can be ensured.

Preferably, the difference between gloss values of the single coating obtained from the gloss test in accordance with ISO 2813 at an angle of 80° before and after the abrasion test with an abrasion wheel CS10F at a load of 250 gram and 500 revolutions in accordance with ASTM D4060 is in the range of 2% to 10%. By setting the change in gloss value in this range, the high strength required for the single layer coating 1 can be ensured. Gloss loss can be related to surface damage. Surface deterioration will possibly scatter the laser beam resulting in signal loss and thus reduce the storage capacity or possible malfunction of the high-capacity optical disc in the drive.

Preferably, the transparency of the single layer coating obtained from ultraviolet-visible absorption spectroscopy measurement should be higher than 85%, more preferably higher than 90% at a wavelength of 405 nm and a layer thickness of single layer coating 1 of 100 μm measured on a UV-3102 PC UV-VIS-NIR spectrophotometer produced by Shimadzu Corporation. By setting the transparency over this value, the readability of the high density optical disc will not be deteriorated. Deterioration of the reading laser will result in signal loss and decrease storage capacity of the high-density optical disc.

Application properties are very important for the final result of the single layer coating on the high-density optical disc: for example, viscosity measured according to DIN 53019 can vary depending on the application machinery from 100 to 10000 mPas and preferably, the shrinkage of the single layer coating obtained in the shrinkage measurement according to U; PHV 623-93/486 (Philips Electronics test standard) is below 7%, more preferably below 6%. By setting the shrinkage under this value the high-density optical disc will have less tendency to bend under the influence of the polymerisation of the liquid coating. Warpage of the high density optical disc will shift the reflected laser beam resulting in quality loss of the electrical signal of the high density optical disc.

The invention is further illustrated by the following non-limiting Examples.

### Examples

All the ingredients shown in Table 1 or Table 2 were mixed on a 100 gram scale with a standard mixer and standard stirrer at 1000 rpm for one hour. The mixture was then placed in an oven at 70° C. for 45-60 minutes. The properties were determined 24 hours after the mixture had first been exposed to 70° C.

TABLE 1

| | A | B |
|---|---|---|
| Example 1 | gram | gram |
| Colloidal silica sol | 50 | |
| (50 wt % SiO2 with Ethoxylated (3) trimethylolpropane | | |
| triacrylate) | | |
| Ethoxylated (3) trimethylolpropane triacrylate | | 50 |
| Polyester acrylate resin | 40 | 40 |
| (Average of 3.1 acrylate groups per molecule/molecular | | |
| weight of approx. 750) | | |
| 1-Hydroxycyclohexyl-phenyl-ketone | 5 | 5 |
| Phenoxyethyl acrylate | 5 | 5 |
| Properties | | |
| Viscosity [mPa · s] | 2110 | 520 |
| Shrinkage [%] | 6 | 7 |
| Gloss loss after taber test [%] | 4.6 | 20.3 |
| Gloss loss after steel wool test [%] | 5.5 | 29.1 |

Ethoxylated (3) trimethylolpropane triacrylate is SR454 from Sartomer
1-Hydroxycyclohexyl-phenyl-ketone is Irgacure 184 from Ciba Chemicals
Phenoxyethyl acrylate is SR339c from Sartomer

TABLE 2

| | A | B |
|---|---|---|
| Example 2 | gram | gram |
| Colloidal silica sol | 70 | |
| (50 wt % SiO2 with polyether glycol 400 diacrylate) | | |
| Polyether glycol 400 diacrylate | | 70 |
| Polyester acrylate resin (Average of 3.1 acrylate | 20 | 20 |
| groups per molecule/molecular weight of approx. 750) | | |
| 1-Hydroxy-cyclohexyl-phenyl-ketone | 5 | 5 |
| Phenoxyethyl acrylate | 5 | 5 |
| Properties | | |
| Viscosity [mPa · s] | 1770 | 250 |
| Shrinkage [%] | 5 | 6.5 |
| Pencil hardness | 6-7H | H |
| Indentation hardness [μm] | 1.7 | 5 |

Polyether glycol 400 diacrylate is SR344 from Sartomer
1-Hydroxycyclohexyl phenyl ketone is Irgacure 184 from Ciba Chemicals
Phenoxyethyl acrylate is SR339c from Sartomer

In the specific examples set forth in the above-referenced Tables, the properties of the products were actually measured as follows:

### Shrinkage:

Shrinkage was measured according to Philips test PHV 623-93/486 (Philips Electronics standard test).

Gloss Loss after Taber Test:

The lacquer was spin coated on a blank CD. Approximately 3 gram was applied to the disc, which was then spun at 600 rpm for 6 seconds to create a layer thickness of approximately 80-120 microns. The lacquer was cured for 3 seconds on a Convac curing unit with a standard H-bulb UV lamp (100 w/cm2). The gloss of the coating was measured according to ISO2813. The taber test (ASTM D4060) with abrasion wheel CS-10 at a load of 250 gram for 500 revolutions was performed. The gloss was measured again (according to ISO2813). The gloss loss was calculated by:

(gloss before−gloss after/gloss before)×100%=gloss loss

Gloss Loss after Steel Wool Test:

The lacquer was spin coated on a blank CD. Approximately. 3 gram was applied to the disc, which was then spun at 600 rpm for 6 seconds to create a layer thickness of approximately 80-120 microns. The lacquer was cured for 3 seconds on a Convac curing unit with a standard H-bulb UV lamp (100 w/cm2). The gloss of the coating was measured according to ISO2813. The cured coating was rubbed 10 times with steel wool with a load of 1 kg. The gloss was measured again (according to ISO2813). The gloss loss was calculated by:

(gloss before−gloss after/gloss before)×100%=gloss loss

### Pencil Hardness:

The pencil hardness was measured according to ISO15184.

### Indentation Hardness:

Indentation hardness was measured according to Philips test U; PHV 623-93/487 (Philips Electronics standard test).

Although preferred embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1-20. (canceled)

21. An energy-curable flowable coating composition comprising:
a surface treated inorganic nanoparticle,
a photoinitiator, and
at least one energy-curable monomer, oligomer or resin.

22. A composition according to claim 21, in which the viscosity of the final formulation is between 100 mPa·s and 10,000 mPa·s.

23. A composition according to claim 21, in which the viscosity of the final formulation is between 500 mPa·s and 5,000 mPa·s.

24. A composition according to claim 21, in which the viscosity of the final formulation is higher than 700 mPa·s but lower than 3.000 mPa·s.

25. A composition according to claim 21, in which said nanoparticles are comprised of silica, alumina, zirconia, a metal, a compound of a metal, or a ceramic.

26. A composition according to claim 25, in which said nanoparticles have a particle size of from 5 to 80 nm.

27. A composition according to claim 25, in which the nanoparticles have a particle size from 9 to 60 nm.

28. A composition according to claim 21, in which the nanoparticle is surface treated with a material having a reactive functional group, such as an epoxy-, (meth)acrylate- or isocyanate group.

29. A composition according to claim 28, in which said nanoparticles have a particle size of from 15 to 30 nm.

30. A composition according to claim 21, in which the amount of nanoparticles is from 15 to 50% by weight of the entire composition.

31. A composition according to claim 21, in which the amount of nanoparticles is from 20 to 40% by weight of the entire composition.

32. A composition according to claim 21, wherein the composition may be cured to an optical disc by exposure to energy, and further wherein the cured composition has a transparency greater than 85% at a the wavelength of 405 nm.

33. A composition according to claim 21, wherein the composition may be cured to an optical disc by exposure to energy, and further wherein the cured composition has a transparency greater than 85% at a the wavelength of 650 nm.

34. A composition according to claim 21, wherein the composition may be cured to an optical disc by exposure to energy, and further wherein the cured composition has a shrinkage after curing of less than 7%.

35. A composition according to claim 21, wherein the composition may be cured to an optical disc by exposure to energy, and further wherein the cured composition has a pencil hardness of at least 4H.

36. A composition according to claim 21, wherein the composition may be cured to an optical disc by exposure to energy, and further wherein the cured composition indentation hardness is under a indentation depth of 5 μm, in accordance with Philips Electronics test standard U; PHV 623-93/487.

37. A composition according to claim 21, wherein the composition may be cured to an optical disc by exposure to energy, and further wherein the cured composition has a gloss loss after the Taber abrasion test of from 2 to 10%.

38. An optical disc comprising:
a substrate;
a reflective layer,
a coating layer comprised of a inorganic nanoparticle, a photoinitiator, and
at least one energy-curable monomer, oligomer or resin.

39. An optical disc according to claim 38, in which said nanoparticles of the coating layer are comprised of silica, alumina, zirconia, a metal, a compound of a metal, or a ceramic.

40. An optical disc according to claim 39, in which said nanoparticles have a particle size of from 5 to 80 nm.

41. An optical disc according to claim 39, in which the nanoparticles are surface treated with a material having a reactive functional group, such as an epoxy-, (meth)acrylate- or isocyanate group.

42. An optical disc according to claim 38, wherein the photoiniator of the coating layer is selected from the group consisting of hydroxycyclohexyl phenyl ketones, benzophenone and its derivatives, acyl phosphine based materials, sulphonium salts, thianthrenium salts; iodonium salts, phenacyl sulphonium salts, and thioxanthonium salts.

43. An optical disc according to claim 38, wherein the coating layer is cured to the reflective layer by exposure to energy, and further wherein the coating layer has a thickness of from 20 to 150 □m.

44. An optical disc according to claim 38, wherein the coating layer is cured to the reflective layer by exposure to energy, and further wherein the coating layer has a transparency greater than 85% at a the wavelength of 405 nm.

45. An optical disc according to claim 38, wherein the coating layer is cured to the reflective layer by exposure to energy, and further wherein the coating layer has a transparency greater than 85% at a the wavelength of 650 nm.

46. An optical disc according to claim 38, wherein the coating layer is cured to the reflective layer by exposure to energy, and further wherein the coating layer has a shrinkage after curing of less than 7%.

47. An optical disc according to claim 38, wherein the coating layer is cured to the reflective layer by exposure to energy, and further wherein the coating layer has a pencil hardness of at least 4H.

48. An optical disc according to claim 38, wherein the coating layer is cured to the reflective layer by exposure to energy, and further wherein the coating layer has a indentation hardness under an indentation depth of 5 μm, in accordance with Philips Electronics test standard U; PHV 623-93/487.

49. An optical disc according to claim 38, wherein the coating layer is cured to the reflective layer by exposure to energy, and further wherein the coating layer has a gloss loss after the Taber abrasion test of from 2 to 10%.
